(19) United States
(12) Patent Application Publication
(10) Pub. No.: US 2008/0271963 A1
(43) Pub. Date: Nov. 6, 2008

(54) Disc Brake for a Commercial Vehicle

(75) Inventors: Wlodzimierz MACKE, Olching (DE); Dietmar Knoop, Ebenhausen (DE)

Correspondence Address: CROWELL & MORING LLP;INTELLECTUAL PROPERTY GROUP, P.O. BOX 14300, WASHINGTON, DC, 20044-4300, US

(73) Assignee: Knorr-Bremse Systeme Fuer Nutzfahrzeuge GmbH, Muenchen (DE)

(21) Appl. No.: 12/106,577

(22) Filed: Apr. 21, 2008

Related U.S. Application Data
(63) Continuation of application No. PCT/EP2006/010141, filed on Oct. 20, 2006.

(30) Foreign Application Priority Data
Oct. 21, 2005 (DE) 10 2005 050 581.3

(51) Int. Cl. F16D 55/22; F16D 65/092

(52) U.S. Cl. 188/73.1; 188/250 R

(57) ABSTRACT

A disc brake, particularly for a commercial vehicle, has a brake caliper, which overlaps a brake disc, and brake pads, which each consist of a friction lining and of a pad supporting plate and which, when in an operational position, contact the brake disc on both sides. Each pad supporting plate rests against a pressure plate, which is supported in the brake caliper, or against a brake caliper supporting surface. The disc brake is designed such that at least one of the pad supporting plates and the associated pressure plate or the supporting surface are provided for transferring loads occurring during braking to its facing contact surfaces with positive locking structures, which correspond with one another and which are provided in the manner of a coding.

### CROSS-REFERENCE TO RELATED APPLICATIONS

This application is a continuation of PCT International Application No. PCT/EP2006/010141, filed on Oct. 20, 2006, which claims priority under 35 U.S.C. §119 to German Application No. 10 2005 050 581.3, filed Oct. 21, 2005, the entire disclosures of which are expressly incorporated by reference herein.

### BACKGROUND AND SUMMARY OF THE INVENTION

The present invention relates to a disc brake and, in particular, a disc brake for a commercial vehicle.

Such a disc brake is known, for example, from DE 199 07 958 A1. DE 199 07 958 A1 shows and describes a brake pad, which consists of a friction lining and a lining carrier plate, which bears on its lining carrier plate side against a pressure plate. The pressure plate is displaceably mounted in a brake caliper. A brake application device is used to press the brake pad against the brake disc.

Since the structural space available in the brake caliper for accommodating the brake pads is relatively small, the lining carrier plate is made to be relatively thin. As a result, problems arise with respect to supporting the loads which occur during braking. For these reasons, it is also problematic to couple the lining carrier plate to the pressure plate.

In addition, incorrect fitting may occur with the known structures because the brake lining may be fitted in a reversed position, i.e., one rotated by 180°, without this being noticed, so that the friction lining is then adjacent the pressure plate and not directed toward the brake disc, as is required.

Moreover, known disc brakes even permit the brake lining to be replaced by other makes that may not be approved for the vehicle or the particular disc brake in question.

This can, of course, restrict the operational safety of the disc brake, which is unacceptable in principle, especially since disc brakes are among the components in a vehicle which are particularly important from a safety point of view.

Although it has already been attempted to code brake pads, such coding is not suitable for performing functional tasks. In addition, the known coding can be removed by simple mechanical working, for example using a hammer and chisel, which means that uncoded brake pads can easily be used by unauthorized manufacturers.

A further criterion with regard to the requisite operational safety is the quality of the friction lining whose identification has, until now, been stamped onto the outside of the lining carrier plate in color or engraved with a stamping tool by a needle stamping method.

After a certain time, however, the corrosion and temperatures which occur during operation destroy these identifications to the point that they can no longer be seen. In the event of damage, therefore, it is frequently not possible to determine whether use was made of a correct brake pad or not.

The present invention is based on the object of further developing a disc brake such that the operational safety is improved with little design and manufacturing complexity.

This object is achieved by providing a disc brake, in particular for a commercial vehicle, having a brake caliper which straddles a brake disc and having brake pads, which are arranged in the brake caliper on both sides with the brake disc. Each brake pad includes a friction lining and a lining carrier plate. Each lining carrier plate bears against a pressure plate, which is supported in the brake caliper, or a supporting surface on the brake caliper side. At least one of the lining carrier plates and the associated pressure plate, or supporting surface, are provided on their mutually facing bearing surfaces of mutually corresponding form-fitting structures, which are formed in the manner of a coding, for transferring loads which occur during braking.

The invention achieves essentially two major advantages. By designing the mutually corresponding form-fitting structures on the lining carrier plate, on the one hand, and the pressure plate or a supporting surface of the brake caliper, on the other hand, only that brake pad which is intended for this use can be fitted. It is ensured that the brake pad can be placed against the pressure plate or the supporting surface only with its lining carrier side and not, as described, with its friction lining surface. In addition, no other product can be used, since the form-fitting structures are designed in such a way that the use of another brake pad which does not have these form-fitting means cannot be used.

In this case, the form-fitting structures can be designed individually, for example in the form of a workpiece identification, a logo, or the like. In this case, the brake pads can be used only in vehicles of a single provider. It is then also possible to permanently engrave the means of identifying the quality of friction lining used.

The coding also permits the prior determination of the brake pads for a specific installation site. It is thus possible to exactly allocate brake pads with different coefficients of friction of the friction linings, as are required for an inner pad and an outer pad, in order, for example, to take into account the different cracking behavior of a brake disc. Interchanging of the two brake pads can therefore be excluded.

The pressure plates are preferably produced from stainless (or almost stainless) material and are designed to have high fatigue strength for the service life of a disc brake.

In addition to the precise and reliable allocation of the brake pad to a particular pressure plate or supporting surface, the loads occurring during braking can be transferred by the form-fitting structures from the brake lining to the pressure plate and, therefore, to the brake caliper in an unrestricted fashion, it being possible to tangentially, radially and, if required, also laterally, support the forces that occur.

The coding or the form-fitting structures can be configured in a simple manner such that a requisite overlap length can be produced in all functionally relevant directions.

In addition, the form-fitting structures can be designed to be mechanically extremely robust and can be subjected to high temperatures through suitable material selection.

The pressure plate can be of one-part or two-part design, wherein, in the case of a two-part design, it is formed from a die sheet, which is provided with the coding and is cast into a carrier plate, for example. In this case, the form-fitting structures on the pressure plate side are formed by recesses which are produced by material-removing machining or punching.

In the case of a one-part design, the pressure plate can be forged or cast, wherein the form-fitting structures are, preferably, designed as depressions into which corresponding form-fitting structures of the lining carrier plate, which are designed as elevations, engage with an accurate fit. By means of cold or hot calibration following the casting, material-removing machining (milling, counter-sinking, drilling), or forging, it is possible to produce corresponding accuracy of the form-fitting structures. Particularly simple fashioning of the form-fitting structures in the pressure plate arises as a result of indentations in different patterns, to which the form-fitting structures of the lining carrier plate are matched.

Further advantageous embodiments of the invention are described and claimed herein.

Other objects, advantages and novel features of the present invention will become apparent from the following detailed description when considered in conjunction with the accompanying drawings.

### BRIEF DESCRIPTION OF THE DRAWINGS

FIG. 1 is a perspective view of a disc brake according to the invention; and

FIGS. 2 to 5 each show perspective views of an exemplary embodiment of a detail of the disc brake.

### DETAILED DESCRIPTION OF THE DRAWINGS

FIG. 1 illustrates a disc brake for a commercial vehicle. The disc brake, in general, includes a brake disc 2 fastened on the wheel side and a brake caliper 1 which straddles the brake disc and on which an application device 5 is arranged.

During braking, the application device 5 is used to press brake pads 3, which are arranged in the brake caliper 1, against both sides of the brake disc 2.

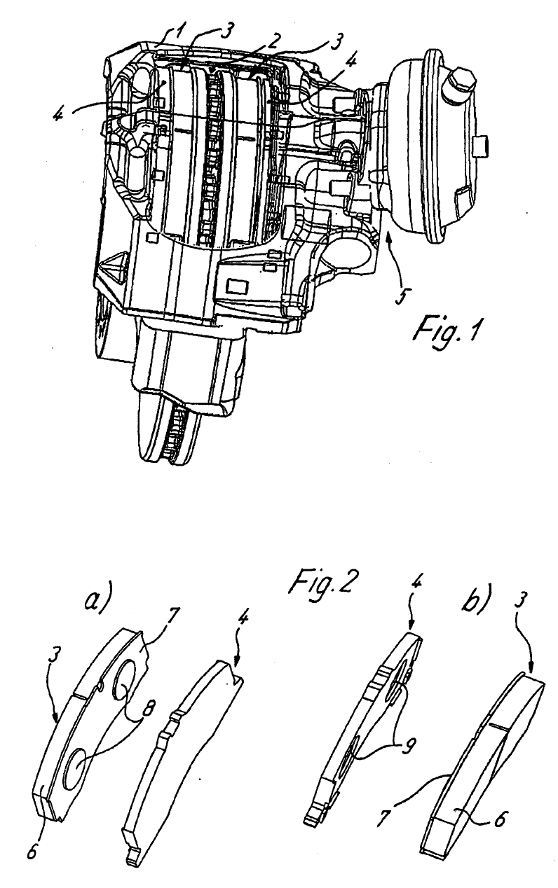

As shown in FIGS. 2-5, each brake pad 3 consists of a lining carrier plate 7 and a friction lining 6, which is fastened to the latter and makes contact with the brake disc 2 when functioning.

Furthermore, each brake pad 3 is supported in the present exemplary embodiment on a pressure plate 4, which is coupled to the brake caliper 1.

According to the invention, the pressure plate 4 and the lining carrier plate 7 have, on their mutually facing bearing surfaces, form-fitting structures 8, 9. These structures 8, 9 are formed in the manner of a coding and serve to transfer the loads which occur during braking.

For this purpose, the form-fitting structure of the brake pad 3 has an elevated form and the associated form-fitting structure 9 of the pressure plate 4 has a depressed form into which the form-fitting structure 8 engages with a substantially accurate fit.

In the exemplary embodiment shown in FIG. 2, the form-fitting structures 8, 9 are circular, wherein, for coding purposes, the form-fitting structures 8, 9 are achieved by different diameters and/or positions. A large number of possible coding combinations can be achieved by the combination of these two parameters. FIG. 2a shows the form-fitting structure 8, formed as elevations, of the brake pad 3, while FIG. 2b, which has been rotated through 180°, shows the form-fitting structure 9 of the pressure plate in the form of recesses.

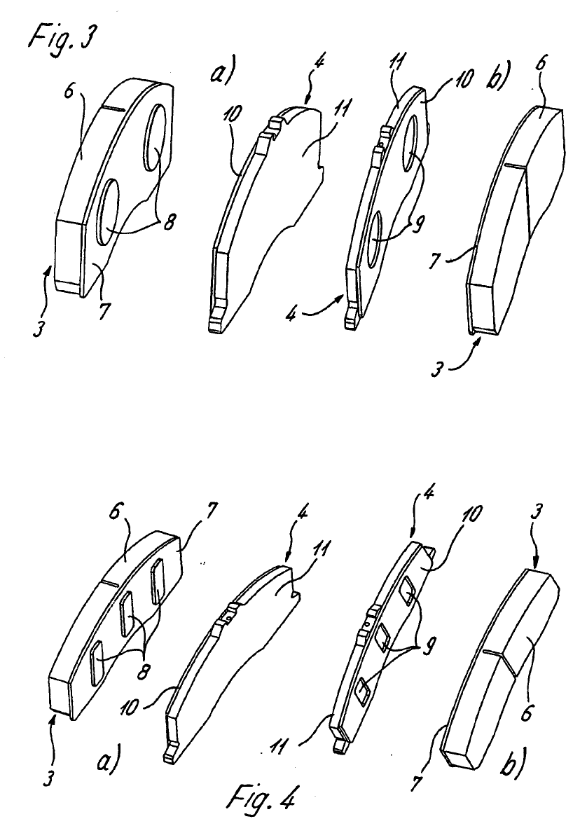

In principle, FIG. 3 shows a comparable design of the form-fitting structures 8, 9 corresponding to that in FIG. 2. Whereas in FIG. 2 the pressure plate 4 is designed as an integral part, the pressure plate 4 according to FIG. 3 consists of two parts, specifically a die sheet 10 and a carrier plate 11, wherein the recesses of the shaped parts 9 are punched into the die sheet 10, and the die sheet 10 is connected to the carrier plate 11 by way of welding, spot-welding, casting, or some other suitable method.

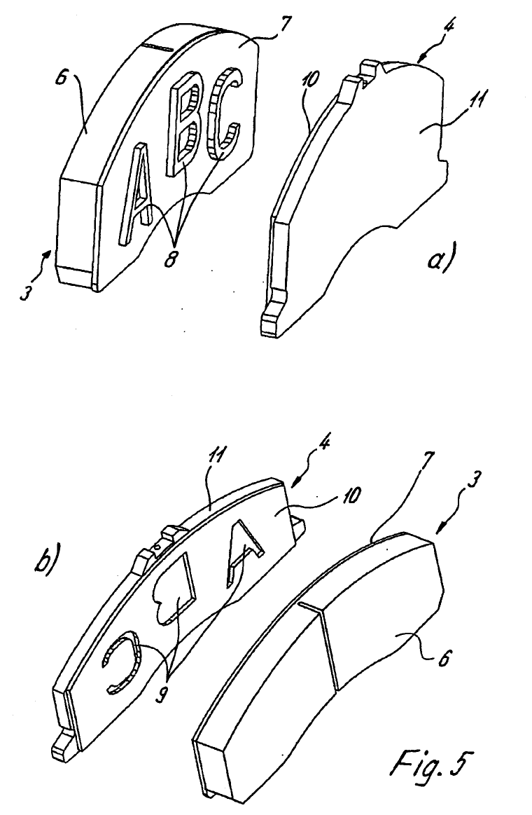

The exemplary embodiment corresponding to FIG. 4 has, as form-fitting structures 8, 9, webs 8 which are elevated on the brake pad side and depressions 9 on the pressure plate side, which are matched to the webs 8 and into which the webs 8 engage in a form-fitting manner.

In FIG. 5, letters are utilized as form-fitting structures 8, 9. The letters are intended to symbolize that customer names, customer logos, or other letterings or identifiers, are stamped into the lining carrier plate 7 in elevated form or are punched or milled into the die sheet 10 in depressed form. The corresponding lettering simultaneously produces the form-fitting connection between the brake pad 3 and the pressure plate 4.

In the same way as in the exemplary embodiment in accordance with FIG. 4, the pressure plate 4 in the example corresponding to FIG. 5 consists of two parts, specifically the die sheet 10 and the carrier plate 11.

It goes without saying that other designs of the form-fitting structures 8, 9 are also contemplated. It is important that together they form a coding and absorb the radial, tangential, and/or lateral forces which occur during braking.

The foregoing disclosure has been set forth merely to illustrate one or more embodiments of the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A disc brake having a brake disc, the disc brake comprising:
a caliper which, in use, straddles the brake disc;
brake pads arranged in the caliper, one of said brake pads being arranged on each side of the brake disc;
each brake pad comprising a friction lining and a lining carrier plate;
one of pressure plates supported in the caliper and caliper supporting surfaces, each pressure plate or caliper supporting surface being operatively configured to bear against a respective lining carrier plate of the brake pad; and
wherein at least one lining carrier plate and the associated pressure plate or the caliper supporting surface comprise mutually corresponding form-fitting structures on mutually facing bearing surfaces for transferring loads occurring during braking, the form-fitting structures being operatively configured as a coding.

2. The disc brake according to claim 1, wherein the form-fitting structures comprise elevations and depressions, the elevations engaging into depressions with a substantially accurate fit.

3. The disc brake according to claim 1, wherein the coding is provided by different shaping of the form-fitting structures.

4. The disc brake according to claim 3, wherein the shaping of the form-fitting structures comprises at least one of geometric shapes, letters, and logos.

5. The disc brake according to claim 1, wherein one of the brake pads arranged on one side of the brake disc has form-fitting structures that are different from another brake pad arranged on an opposite side of the brake disc.

6. The disc brake according to claim 1, wherein the pressure plate comprises a rigid carrier plate and a die sheet, the die sheet being fixedly connected to the rigid carrier plate.

7. The disc brake according to claim 6, wherein the lining carrier plate comprises elevated form-fitting structures, and one of the pressure plate and die sheet has corresponding depressed form-fitting structures.

8. The disc brake according to claim 1, wherein the form-fitting structures are operatively configured to absorb braking loads that occur in at least one of radial, tangential, and lateral directions.

9. The disc brake according to claim 1, wherein the pressure plate comprises one of a cast and forged pressure plate.

10. A brake pad for use in a disc brake having a pressure plate or caliper support surface arranged in a caliper of the disc brake on one side of a brake disc, the brake pad comprising:
a friction lining that, in use, presses against the brake disc of the disc brake;
a lining carrier plate attached to one side of the friction lining which faces away from the brake disc when installed; and
wherein a form-fitting structure is configured on the lining carrier plate for positive engagement with a corresponding form-fitting structure arranged on the pressure plate or the caliper supporting surface that bears against the lining carrier plate when in use.

11. The brake pad according to claim 10, wherein the form-fitting structure of the lining carrier plate is operatively configured as a coding.

12. The brake pad according to claim 11, wherein the coding is formed by different shaping of the form-fitting structure.

13. The brake pad according to claim 12, wherein the different shaping is at least one of a geometric shape, a letter, and a logo.
